(19) United States
(12) Patent Application Publication
(10) Pub. No.: US 2016/0301249 A1
(43) Pub. Date: Oct. 13, 2016

(54) COMMUNICATING BETWEEN GALVANICALLY ISOLATED DEVICES USING WAVEGUIDES

(71) Applicant: Infineon Technologies AG, Neubiberg (DE)

(72) Inventors: Dirk Hammerschmidt, Villach (AT); Harald Witschnig, Reimerling (DE); Patrick Leteinturier, Landskron (AT)

(21) Appl. No.: 14/682,766

(22) Filed: Apr. 9, 2015

(51) Int. Cl. H02J 17/00

(52) U.S. Cl. CPC H02J 17/00

(57) ABSTRACT

In one example, a system includes one or more waveguides configured to guide radio frequency (RF) signals, a controller comprising a transmitter configured to output RF signals representing a control signal via the one or more waveguides, and a power module. In this example, the power module includes a receiver configured to receive the RF signals representing the control signal from the controller via the one or more waveguides, and a driver configured to output a power signal to a load based on the control signal.

### TECHNICAL FIELD

This disclosure relates to communicating across galvanic isolation boundaries.

### BACKGROUND

Electronic systems, such as electronic drive systems in vehicles, generally include an electronic control unit (ECU) or controller, a power module, and a load. The ECU may be configured to output control signals to the power module which cause the power module to output a power signal to operate the load. In some examples, the power module may be supplied from a high voltage domain, while the ECU may be supplied from a low voltage domain. To prevent catastrophic damage of components supplied from the low voltage domain and assure safe maintainability, components supplied from the high voltage domain of the electronic system may be galvanically isolated from the low voltage domain. This isolation may be implemented anywhere between the ECU and the power module.

### SUMMARY

In one example, a system includes one or more waveguides configured to guide radio frequency (RF) signals, a controller comprising a transmitter configured to output RF signals representing a control signal via the one or more waveguides, and a power module. In this example, the power module includes a receiver configured to receive the RF signals representing the control signal from the controller via the one or more waveguides, and a driver configured to output a power signal to a load based on the control signal.

In another example, a method includes receiving, by a receiver of power module and from a controller, RF signals representing control signals via one or more waveguides configured to guide RF signals between the controller and the power module, wherein the power module is galvanically isolated from the controller; and outputting, by a driver of the power module and based on the control signals, a power signal to a load.

In another example, a power module includes a receiver configured to receive, from a controller, RF signals representing control signals via one or more waveguides configured to guide RF signals between the controller to the power module such that of the power module is galvanically isolated from the controller; and a driver configured to output a power signal to a load based on the control signals.

In another example, a power module includes means for receiving, from a controller, RF signals representing control signals via a waveguide configured to guide RF signals between the controller to the power module such that of the power module is galvanically isolated from the controller; and means for outputting a power signal to a load based on the control signals.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example system that includes one or more waveguides configured to enable communication between galvanically isolated components, in accordance with one or more exemplary techniques of this disclosure.

FIG. 2 is a conceptual diagram illustrating details of one example system 2 of FIG. 1 that includes one or more waveguides configured to enable communication between galvanically isolated components, in accordance with one or more exemplary techniques of this disclosure.

FIG. 3 is a conceptual diagram illustrating details of another example of system 2 of FIG. 1 that includes one or more waveguides configured to enable communication between galvanically isolated components, in accordance with one or more exemplary techniques of this disclosure.

FIG. 4 is a conceptual diagram illustrating details of another example of system 2 of FIG. 1 that includes one or more waveguides configured to enable communication between galvanically isolated components, in accordance with one or more exemplary techniques of this disclosure.

FIG. 5 is a flowchart illustrating exemplary operations of an example power module which communicates with a controller via one or more waveguides, in accordance with one or more techniques of this disclosure.

FIG. 6 is a flowchart illustrating exemplary operations of an example controller which communicates with a power module via one or more waveguides, in accordance with one or more techniques of this disclosure.

### DETAILED DESCRIPTION

In general, this disclosure is directed to systems and methods that facilitate communication between galvanically isolated devices, such as in electronic systems. For instance, an electronic control unit (ECU), that is galvanically isolated from a power module, may output control signals to the power module which cause the power module to output a power signal to operate a load. In some examples, the power module may be supplied from a high voltage (e.g., 400 volt (V)) domain, while the ECU may supplied by supplied from a low voltage (e.g., 12V) domain.

In some examples, a system may include a device to galvanically isolate device that are supplied from a high voltage domain from other devices that are supplied from a low voltage domain. For instance, in addition to an ECU and a power module, a system may include a driver board that is coupled to both the ECU and the power module. For instance, the driver board may be connected (e.g., via one or more conductive wires) to the ECU and connected (e.g., via one or more conductive wires) to the power module. As the ECU may be supplied from the low voltage domain and the power module may be supplied from the high voltage domain, such connections may expose the driver board to both the low voltage domain and the high voltage domain. In some examples, the driver board may be an integrated circuit (IC).

In some examples, the driver board may include one or more components that galvanically isolate devices that are supplied from the high voltage domain from other devices that are supplied from the low voltage domain. As one example, the driver board may include one or more coreless transformers configured to galvanically isolate a power module supplied from a high voltage domain from an ECU supplied from a low voltage domain. For instance, a coreless transformer may include a winding coupled to the ECU, a second winding connected to the power module, and an insulating material separating the first winding from the second winding. The first winding may convert an electrical signal in the low voltage domain into a magnetic field which passes through the insulating material, and the second winding may convert the magnetic field into an electrical signal in the high voltage domain. As the insulating material separates the first winding from the second winding, the ECU is galvanically isolated from the power module.

As another example, the driver board may include one or more optocouplers configured to galvanically isolate devices supplied from a high voltage domain from devices supplied from a low voltage domain. For instance, an optocoupler may include a light emitter coupled to an ECU supplied from low voltage domain and a light detector coupled to a power module supplied from a high voltage domain. The light emitter may output an optical signal based on an electrical signal in the low voltage domain and the light detector may convert the optical signal into an electrical signal in the high voltage domain. As the connection between the ECU and the power module is optical, the ECU is galvanically isolated from the power module.

However, in some examples, it may be undesirable to use an optocoupler or a coreless transformer to galvanically isolate a high voltage domain from a low voltage domain. For instance, for both coreless transformers and optocouplers, the isolation can only be realized over very short distance (e.g., on the order of millimeters) in many cases coreless transformers and optocouplers may need to be located inside a single package. The short distance between voltage domains may require high standards of the quality of the used material and fabrication processes. Furthermore, both coreless transformers and optocouplers still need to have high voltage and low voltage supply connections within a short distance e.g. the two sides of a package which means at least a few centimeters. Additionally, optocouplers and coreless transformers may be costly both in terms of price and board area. In some examples, these costs are amplified because a separate optocoupler or coreless transformer may be needed for each connection. Thus, in order to mitigate or eliminate these limitations and concerns, it may be desirable to enable galvanic isolation between a high voltage domain and a low voltage domain over “long” distances (e.g. greater than 25 cm).

In some examples, it may also be desirable for the ECU to communicate additional information with the power module. For instance, it may be desirable for the ECU to receive feedback about the output state and the operation point (e.g., operational values) of the power module, e.g., in order to improve the quality of the load control and prevent damage due to overheating. Some example operational values may include, but are not necessarily limited to, an output voltage, an output current, and a temperature. In some examples, the ECU may utilize the feedback to adjust the operation of the power module. As such, it may be desirable to minimize latency in the delivery of the feedback information, e.g., to reduce the control latency time and/or reduce fault reaction times. Additionally, it may be desirable to increase the amount of information which may be communicated between the ECU and the power module.

In addition to enabling feedback from the power module at a high rate, it may also be desirable for the communication channel between the ECU and the power module to be reliable and allow for sufficient redundancy to prevent fail decisions of the controller or safety mechanisms based on faulty measurement data after the data is transmitted between the galvanically isolated high voltage domain and low voltage domain. As such, it is desirable for an ECU to be able to reliably communicate large amounts of data with a power module over a galvanic isolation boundary with minimal delay.

In accordance with one or more techniques of this disclosure, one or more waveguides may be used to enable communication between galvanically isolated components. For instance, as opposed to using a separate driver board that is coupled to both sides of the galvanic isolation barrier, one or more waveguides may be used to enable communication between galvanically isolated controller and power module by guiding RF signals between the controller and the power module. As one example, the controller may include a transmitter configured to output RF signals representing a control signal via the one or more waveguides and the power module may include a receiver configured to receive the RF signals representing the control signal from the controller via the one or more waveguides. In some examples, the power module may also include a driver configured to output a power signal to a load based on the control signal. In some examples, the one or more waveguides may be made of an electrical insulating material, such as plastic, the inclusion of the waveguides does not compromise the galvanic isolation. In this way, the controller may cause a power signal to be output to the load while remaining galvanically isolated from the power module and the load. Also in this way, the number of integrated circuits may be reduced (e.g., because a separate driver board may not be needed to enable galvanic isolation). In other words, as opposed to creating a galvanic isolation boundary between components within a separate driver board, techniques of this disclose use plastic waveguides to create a galvanic isolation boundary between the controller and the power module.

In some examples, the one or more waveguides may be used to enable bidirectional communication between galvanically isolated components. For instance, the power module may include a measurement module configured to measure one or more operational values of the power module and a transmitter configured to output RF signals representing the one or more operational values to the controller via the one or more waveguides. In this way, the power module may provide feedback to the controller while remaining galvanically isolated from the controller.

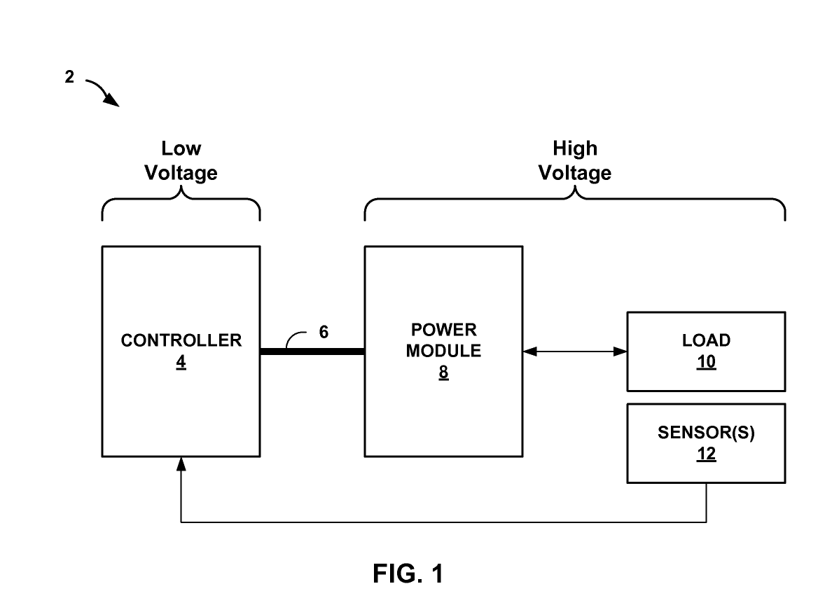

FIG. 1 is a conceptual diagram illustrating an example system that includes one or more waveguides configured to enable communication between galvanically isolated components, in accordance with one or more exemplary techniques of this disclosure. As illustrated in FIG. 1, system 2 includes controller 4, one or more waveguides 6, power module 8, load 10, and one or more sensors 12. In some examples, system 2 may be included in a vehicle. For instance, system 2 may be included in an electrical vehicle (EV), such as a plug-in electrical vehicle (PEV), a hybrid electric vehicle, a plug-in hybrid vehicle (PHEV), and the like.

In some examples, system 2 may include controller 4, which may be configured to control operation of one or more other components of system 2, such as load 10. In some examples, controller 4 may control the operation of load 10 by outputting control signals to power module 8 that cause power module 8 to output a power signal to operate load 10. In some examples, such as where system 2 is included in a vehicle, controller 4 may output the control signals based on a position of a throttle (e.g., accelerator pedal) of the vehicle. In some examples, controller 4 may be powered by a low voltage domain. For instance, controller 4 may be powered by a power signal with a voltage of 3.3V, 5V, 12V, 24V, or another suitable voltage. Examples of controller 4 may include, but are not limited to, one or more processors, including, one or more microprocessors, digital signal processors (DSPs), application specific integrated circuits (ASICs), field programmable gate arrays (FPGAs), or any other equivalent integrated or discrete logic circuitry, as well as any combinations of such components.

In some examples, system 2 may include power module 8, which may be configured to output a power signal to load 10. In some examples, power module 8 may output the power signal to load 10 in response to a control signal, such as a control signal received from controller 4. In some examples, power module 8 may be powered by a high voltage domain. For instance, power module 8 may be powered by a power signal with a voltage of 100V, 200V, 400V, 600V, or another suitable voltage.

In some examples, system 2 may include load 10, which may be configured to perform one or more operations in response to receiving a power signal. Example of load 10 include, but are not limited to, lighting elements, motors, and valves. As one example, load 10 may include a motor configured to convert electrical energy into kinetic energy. For instance, where system 2 is included in a vehicle, the motor may be configured to propel the vehicle (e.g., to provide a mechanical driving force to one or more wheels), or actuate a seat/window/mirror of the vehicle. In some examples, the motor may be a multi-phase electrical motor. For instance, the motor may be a three-phase electrical motor. In some examples, load 10 may be powered by a high voltage domain. For instance, load 10 may receive electrical energy in the form of a power signal from power module 8 which may have a voltage of 100V, 200V, 400V, 600V, or another suitable voltage.

In some examples, system 2 may include one or more sensors 12, which may be configured to measure one or more parameters of load 10. As one example, where load 10 includes a motor, sensors 12 may include a position sensor configured to sense a position of the motor. As another example, sensors 12 may include a temperature sensor configured to sense a temperature of load 10. In some examples, sensors 12 may be powered by the low voltage domain. For instance, sensors 12 may be powered by a power signal with a voltage of 3.3V, 5V, 12V, 24V, or another suitable voltage.

In some examples, system 2 may include one or more waveguides 6, which may be configured to guide radio frequency (RF) signals. For instance, waveguides 6 may be configured to guide RF signals in the range of 10-500 GHz. As illustrated in FIG. 1, one or more of waveguides 6 may be connected between controller 4 and power module 8. In some examples, waveguides 6 may be made from an insulating material, such as plastic, glass, or any other suitable insulating material formable into a waveguide. For instance, waveguides 6 may be made from polypropylene, polystyrene, polyethylene, or any other suitable plastic. As such, even where a waveguide of waveguides 6 is connected to both controller 4 and power module 8, controller 4 and power module 8 may remain galvanically isolated. In some examples, a length of one of more of waveguides 6, such as a waveguide of waveguides 6 connected between controller 4 and power module 8, may be greater than 25 centimeters, 50 centimeters, 1 meter, 2 meters, or another suitable distance. In some examples, the dimensions (e.g., cross sectional shape) of waveguides 6 may be selected based on one or more factors, such as the frequency of the RF signals, and the length of the waveguide.

In some examples, controller 4 may communicate with power module 8. However, as it may be desirable for controller 4 to be galvanically isolated from power module 8, controller 4 may not communicate with power module 8 via a direct electrical connection. In accordance with one or more techniques of this disclosure, controller 4 may communicate with power module 8 by outputting RF signals to power module 8 via one or more of waveguides 6. For instance, controller 4 may output RF signals representing a control signal via one or more of waveguides 6 connected between controller 4 and power module 8. Power module 8 may receive the RF signals representing the control signal from controller 4 via the one or more of waveguides 6. Power module 8 may output a power signal to load 10 based on the received control signals. In this way, controller 4 may control operation of power module 8 while remaining galvanically isolated from power module 8.

In some examples, the communication between controller 4 and power module 8 may be bi-directional. For instance, as opposed to just receiving signals from controller 4, power module 8 may output signals, such as feedback signals, to controller 4. To output the signals to controller 4, power module 8 may output RF signals representing one or more operational values of power module 8 to controller 4 via one or more of waveguides 6. In this way, power module 8 may output feedback signals to controller 4 while remaining galvanically isolated from controller 4.

In some examples, controller 4 and power module 8 may bi-directionally communicate via a single waveguide of waveguides 6. For instance, controller 4 may output RF signals to power module 8 via the same waveguide of waveguides 6 that power module 8 uses to output RF signals to controller 4. In some examples, controller 4 and power module 8 may bi-directionally communicate via multiple waveguides of waveguides 6. For instance, controller 4 may output RF signals to power module 8 via a first waveguide of waveguides 6 and power module 8 may output RF signals to controller 4 via a second waveguide of waveguides 6 that is different from the first waveguide of waveguides 6.

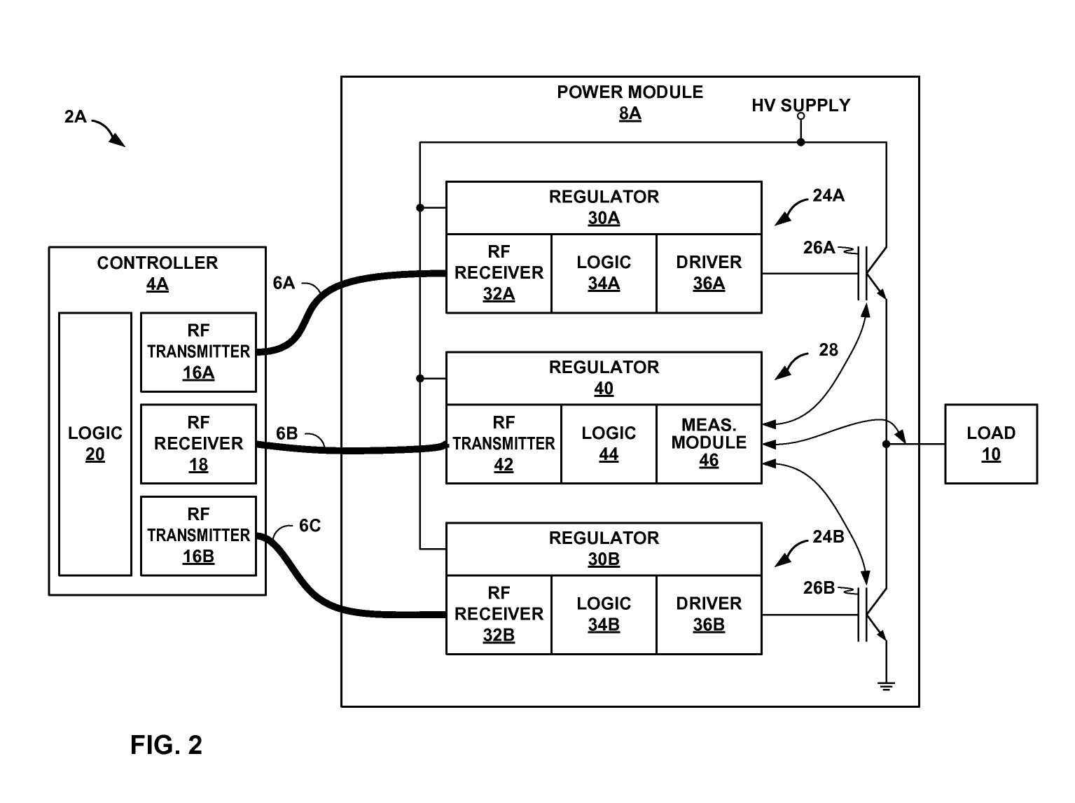

FIG. 2 is a conceptual diagram illustrating details of one example system 2 of FIG. 1 that includes one or more waveguides configured to enable communication between galvanically isolated components, in accordance with one or more exemplary techniques of this disclosure. System 2A may be an example of system 2 of FIG. 1. As illustrated in FIG. 2, system 2A includes controller 4A, waveguides 6A-6C, power module 8A, and load 10. In some examples, system 2A may include one or more components not illustrated in FIG. 2, such as one or more sensors, which may be configured to perform operations similar to sensors 12 of FIG. 1.

In some examples, system 2A may include controller 4A, which may be configured to perform operations similar to controller 4 of FIG. 1. For instance, controller 4A may be configured to control operation of one or more other components of system 2A, such as load 10. As illustrated in FIG. 2, controller 4A may include RF transmitters 16A and 16B (collectively, “RF transmitters 16”), RF receiver 18, and logic 20. Similar to controller 4 of FIG. 1, controller 4A may be powered by a low voltage domain. For instance, the components of controller 4A (e.g., RF transmitters 16, RF receiver 18, and/or logic 20) may be powered by a power signal with a voltage of 3.3V, 5V, 12V, 24V, or another suitable voltage.

Controller 4A, in some examples, may include RF transmitters 16, which may be configured to output RF signals to one or more components of system 2, such as power module 8A. In some examples, RF transmitters 16 may be configured to output RF signals based on signals received from one or more components of controller 4A. For instance, responsive to receiving data indicative of control signals from logic 20, RF transmitters 16 may be configured to output RF signals representing the control signals. In some examples, each of RF transmitters 16 may be configured to output RF signals via a separate waveguide of waveguides 6. For instance, as illustrated in FIG. 2, RF transmitter 16A may be configured to output RF signals via waveguide 6A, and RF transmitter 16B may be configured to output RF signals via waveguide 6C.

Controller 4A, in some examples, may include RF receiver 18, which may be configured to receive RF signals from one or more components of system 2, such as power module 8A. In some examples, RF receiver 18 may be configured to output signals based on the received RF signals to one or more components of controller 4A. For instance, responsive to receiving RF signals that represent one or more operational values from power module 8A, RF receiver 18 may be configured to output data indicative of the one or more operational values to logic 20. In some examples, RF receiver 18 may be configured to receive RF signals via a different waveguide of waveguides 6 than RF transmitters 16 are configured to output RF signals. For instance, as illustrated in FIG. 2, RF receiver 18 may be configured to receive RF signals via waveguide 6B.

In some examples, RF transmitters 16 and RF receiver 18 may be discrete components. In some examples, one or more of RF transmitters 16 and RF receiver 18 may be combined into a single component, which may be referred to as an RF transceiver.

Controller 4A, in some examples, may include logic 20, which may be configured to control operation of load 10. For instance, logic 20 may maintain a control loop which controls operation of load 10. In some examples, the inputs to the control loop may include feedback information received from power module 8A. For instance, logic 20 may use one or more operational values received from power module 8A (e.g., via waveguide 6B and RF receiver 18) as inputs to the control loop. In some examples, the inputs the control loop may also include data received from one or more sensors, such as one or more of sensors 12 of FIG. 1 (not illustrated in FIG. 2 for simplicity). In some examples, the outputs of the control loop may be control signals output to power module 8A. For instance, logic 20 may output control signals (e.g., via waveguides 6A and 6B, and RF transmitters 16) to cause power module 8A to output power signals to load 10.

In some examples, system 2A may include power module 8A, which may be configured to perform operations similar to power module 8 of FIG. 1. For instance, power module 8A may be configured to may be configured to output a power signal to load 10 based on control signals received from controller 4A. As illustrated in FIG. 2, power module 8A may include driver modules 24A and 24B (collectively, “driver modules 24”), transistors 26A and 26B (collectively, “transistors 26”), and feedback module 28. Similar to power module 8 of FIG. 1, power module 8A may receive power from a high voltage domain. For instance, one or more components of power module 8A (e.g., driver modules 24, transistors 26, and/or feedback module 28) may be powered by a power signal with a voltage of 100V, 200V, 400V, 600V, or another suitable voltage.

Power module 8A, in some examples, may include driver modules 24, which may be configured to generate signals to operate transistors 26. For instance, each of driver modules 24 may be configured to generate signals to operate a respective transistor of transistors 26 based on control signals received from controller 4A. As illustrated in FIG. 2, each of driver module 24 may include a regulator of regulators 30A and 30B (collectively, “regulators 30”), an RF receiver of RF receivers 32A and 32B (collectively, RF receivers 32″), a logic of logic 34A and 34B (collectively, “logic 34”), and a driver of drivers 36A and 36B (collectively, “drivers 36”). For instance, driver module 24A may include RF receiver 32A, logic 34A, and driver 36A; and driver module 24B may include RF receiver 32B, logic 34B, and driver 36B.

Driver modules 24, in some examples, may include a regulator of regulators 30, which may be configured to supply components of driver modules 24 with one or more local, galvanically decoupled, low voltages. For instance, regulator 30 of driver module 24 may be configured to supply RF receiver 32A, logic 34A, and driver 36A with a 12V signal. In some examples, regulators 30 may be configured to generate the low voltages from a high voltage supply. For instance, regulators 30 may generate a 12V signal from HV supply (which, as discussed above, may have a voltage of 100V, 200V, 400V, 600V).

Driver modules 24, in some examples, may include a RF receiver of RF receivers 32, which may be configured to receive RF signals from one or more components of system 2, such as controller 4A. In some examples, each of RF receivers 32 may be configured to output signals based on the received RF signals to one or more components of respective driver modules 24. For instance, responsive to receiving RF signals that represent control signals from controller 4A, RF receiver 32A may be configured to output data indicative of the control signals to logic 34A. In some examples, each of RF receivers 32 may be configured to receive RF signals via a separate waveguide of waveguides 6. For instance, as illustrated in FIG. 2, RF receiver 32A may be configured to receive RF signals via waveguide 6A, and RF receiver 32B may be configured to receive RF signals via waveguide 6C.

Driver modules 24, in some examples, may include a logic of logic 34 and a driver of drivers 36A, which may be configured to generate signals to operate transistors 26 based on the control signals received from controller 4A. For instance, based the control signals received from controller 4A, logic 34A of driver module 24A may cause driver 36A to output a signal to a gate of transistor 26A that causes transistor 26A to output a power signal to load 10. In some examples, the signals generated by drivers 36 may be pulse-width modulation (PWM) signals.

Power module 8A, in some examples, may include transistors 26, which may be configured to output a power signal to load 10. In some examples, each of transistors 26 may be configured to output a power signal based on a gate control signal received from a driver module of driver modules 24. Examples of transistors 26 include, but are not limited to, one or more power transistors, one or more metal-oxide-semiconductor field-effect transistors (MOSFETs), one or more thyristors, one or more insulated-gate bipolar transistors (IGBTs), and/or a combination of the same. Some example MOSFETs that may be included in transistors 26 include, but are not limited to, one or more double-diffused metal-oxide-semiconductor (DMOS) MOSFETs, one or more P-substrate (PMOS) MOSFETs, one or more trench (UMOS) MOSFETS, and one or more super-junction deep-trench MOSFETs (e.g., one or more CoolMOS™ MOSFETs).

Power module 8A, in some examples, may include feedback module 28, which may be configured to provide feedback information to controller 4A. As illustrated in FIG. 2, feedback module 28 may include regulator 30, RF transmitter 42, logic 44, and measurement module 46.

Feedback module 28, in some examples, may include regulator 40, which may be configured to perform operations similar to regulators 30. For instance, regulator 40 may be configured to supply components of feedback module 28 with one or more local, galvanically decoupled, low voltages generated from the high voltage supply. In some examples, as opposed to including regulator 40, feedback module 28 may receive power from one of regulators 30.

Feedback module 28, in some examples, may include measurement module 46, which may be configured to measure one or more operational values. For instance, measurement module 28 may be configured to measure one or more operational values of driver modules 24, transistors 26, and/or load 10. Example operational values which may be measured by measurement module 46 include, but are not limited to, current levels (e.g., current levels flowing through transistors 26 and/or load 10), voltage levels (e.g., voltage levels of transistors 26 and/or load 10), and temperatures (e.g., temperatures of transistors 26 and/or load 10).

Feedback module 28, in some examples, may include logic 44, which may be configured to cause RF transmitter 42 to output RF signals representing at least one of the one or more operational values to one or more components of system 2A, such as controller 4A. For instance, logic 44 may cause RF transmitter 42 to output RF signals representing a temperature of transistor 26A and a voltage across transistor 26A to controller 4A via waveguide 6B.

Feedback module 28, in some examples, may include RF transmitter 42 which may be configured to output RF signals to one or more components of system 2, such as controller 4A. In some examples, RF transmitter 42 may be configured to output RF signals based on signals received from one or more components of feedback module 28. For instance, responsive to receiving data indicative of one or more operational values from logic 44, RF transmitter 42 may be configured to output RF signals representing the one or more operational values. In some examples, RF transmitter 42 may be configured to output RF signals via a different waveguide of waveguides 6 than RF receivers 32 are configured to receive RF signals. For instance, as illustrated in FIG. 2, RF transmitter 42 may be configured to transmit RF signals via waveguide 6B.

In operation, controller 4A may control operation of load 10. For instance, logic 20 may output control signals to RF transmitters 16, which may output RF signals representing the control signals (e.g., PWM, ASK, FSK, or PSK control signals) to RF receivers 32 via one or more of waveguides 6. As one example, logic 20 may output a PWM control signal to RF transmitter 16A. Responsive to receiving the PWM control signal, RF transmitter 16A may modulate the PWM control signal on to an RF carrier frequency, which may be between 10 GHz and 500 GHz, and output the modulated PWM control signal to RF receiver 32A via waveguide 6A.

Power module 8A may output a power signal to load 10 based on the control signals output by logic 20. For instance, RF receivers 32 may receive the RF signals representing the control signals, and output the control signals to logics 34 which may cause drivers 36 to output a power signal to load 10. As one example, RF receiver 32A may demodulate the modulated PWM control signal received from RF transmitter 16A, and output the demodulated PWM control signal to logic 34A. Responsive to receiving the PWM control signal, logic 34A and driver 36A may output a signal to the gate of transistor 26A that causes transistor 26A to allow current to flow (or prevent current from flowing) from HV supply to load 10.

Feedback module 28 may provide feedback to controller 4A. For instance, logic 44 may cause measurement module 46 to measure one or more operational values of power module 8A, and cause RF transmitter 42 to output RF signals representing the one or more operational values to RF receiver 18 of controller 4A via waveguide 6B. As one example, logic 44 may cause measurement module 46 to measure a temperature of transistor 26A, and a current level flowing through load 10, and cause RF transmitter 42 to output RF signals representing the measured temperature of transistor 26A, and the measured current level flowing through load 10.

Controller 4A may adjust the control signals based on feedback received from power module 8A. For instance, a control loop maintained by logic 20 may utilize some or all of the feedback received from power module 8A to adjust the control signals. As one example, if the feedback indicates that the temperature of transistor 26A is above a threshold, logic 20 may adjust the control signals to reduce the temperature of transistor 26A. For instance, logic 20 may adjust the control signals to reduce a duty cycle of transistor 26A.

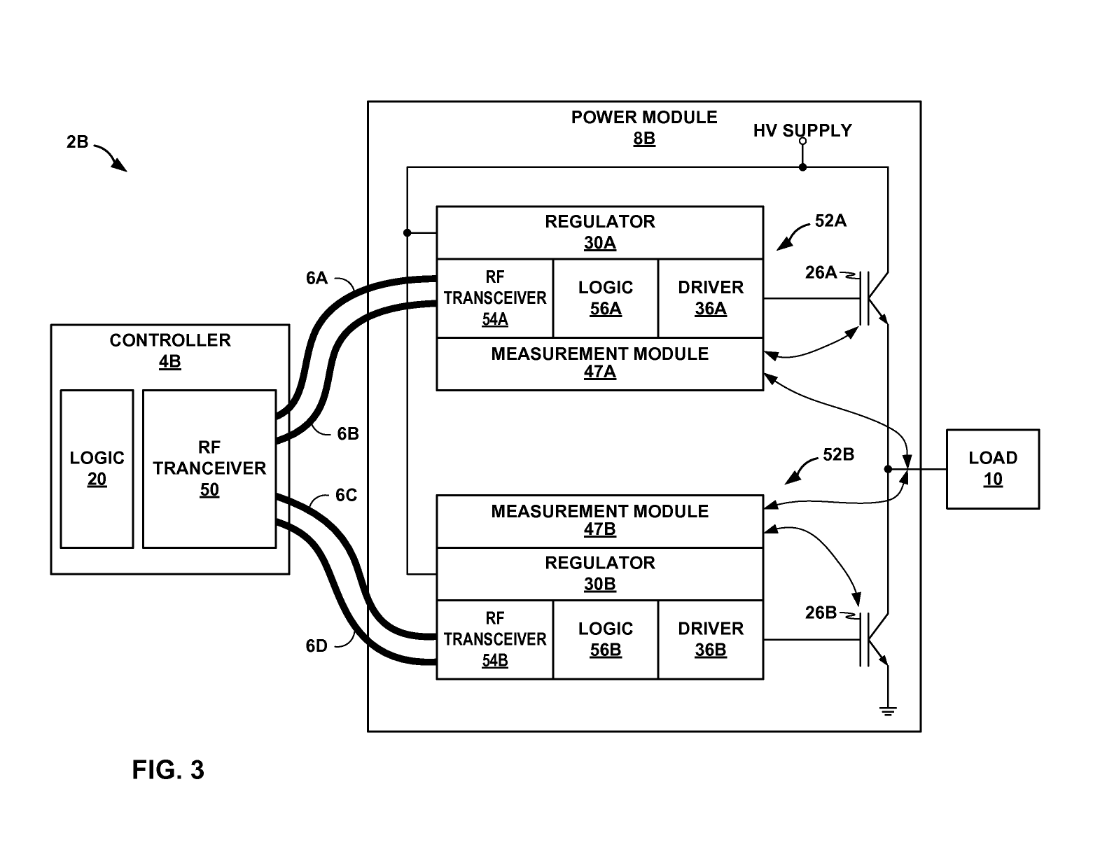

FIG. 3 is a conceptual diagram illustrating details of another example of system 2 of FIG. 1 that includes one or more waveguides configured to enable communication between galvanically isolated components, in accordance with one or more exemplary techniques of this disclosure. System 2B may be an example of system 2 of FIG. 1. As illustrated in FIG. 3, system 2B includes controller 4B, waveguides 6A-6D, power module 8B, and load 10. In some examples, system 2B may include one or more components not illustrated in FIG. 3, such as one or more sensors, which may be configured to perform operations similar to sensors 12 of FIG. 1.

In some examples, system 2B may be configured to perform operations similar to system 2 of FIG. 1, and system 2A of FIG. 2. However, as opposed to power module 8A which is illustrated as including a separate module to measure and output feedback signals (i.e., feedback module 28), power module 8B includes enhanced driver modules which each perform some or all of the functions of feedback module 28. In this way, system 2B may enable communication between controller 4B and power module 8C, while maintain galvanic isolation between controller 4B and enhanced driver modules 52.

In some examples, system 2B may include controller 4B, which may be configured to perform operations similar to controller 4 of FIG. 1 and controller 4A of FIG. 2. For instance, controller 4B may be configured to control operation of one or more other components of system 2B, such as load 10. As illustrated in FIG. 3, controller 4B may include RF transceiver 50, and logic 20. Similar to controller 4 of FIG. 1, controller 4B may be powered by a low voltage domain. For instance, the components of controller 4B (e.g., RF transceiver 50, and/or logic 20) may be powered by a power signal with a voltage of 3.3V, 5V, 12V, 24V, or another suitable voltage.

Controller 4A, in some examples, may include RF transceiver 50, which may be configured to perform operations similar to RF transmitters 16 and RF receiver 18 of FIG. 2. For instance, RF transceiver 50 may be configured to exchange RF signals with one or more components of system 2, such as power module 8B. In some examples, RF transceiver 50 may be configured to output RF signals and receive RF signals via different waveguides. For instance, as illustrated in the example of FIG. 3, RF transceiver 50 may output RF signals via waveguides 6A and 6C, and receive RF signals via waveguides 6B and 6D. In some examples, RF transceiver 50 may be configured to output RF signals and receive RF signals via shared waveguides. For instance, RF transceiver 50 may output and receive RF signals via waveguides 6A and 6C.

In some examples, system 2B may include power module 8B, which may be configured to perform operations similar to power module 8 of FIG. 1 and power module 8A of FIG. 2. For instance, power module 8B may be configured to may be configured to output a power signal to load 10 based on control signals received from controller 4B. As illustrated in FIG. 3, power module 8B may include enhanced driver modules 52A and 52B (collectively, “enhanced driver modules 52”), and transistors 26. Similar to power module 8 of FIG. 1, power module 8B may receive power from a high voltage domain. For instance, one or more components of power module 8B (e.g., enhanced driver modules 52 and/or transistors 26) may be powered by a power signal with a voltage of 100V, 200V, 400V, 600V, or another suitable voltage.

Power module 8B, in some examples, may include enhanced driver modules 52, which may be configured to perform operations similar to driver modules 24 and feedback module 28 of FIG. 2. For instance, each of enhanced driver modules 52 may be configured to generate signals to operate transistors 26 and to provide feedback information to controller 4B. As illustrated in FIG. 3, enhanced driver modules 52 may include a regulator of regulators 30, an RF transceiver of RF transceivers 54A and 54B (collectively, RF transceivers 54″), a logic of logic 56A and 56B (collectively, “logic 56”), a measurement module of measurement modules 47A and 47B (collectively, “measurement modules 47”), and a driver of drivers 36. For instance, enhanced driver module 52A may include RF transceiver 54A, logic 56A, measurement module 47A, and driver 36A; and enhanced driver module 52B may include RF transceiver 54B, logic 56B, measurement module 47B, and driver 36B.

Enhanced driver modules 52, in some examples, may include a RF transceiver of RF transceivers 54, which may be configured to perform operations similar to an RF receiver of RF receivers 32 and RF transmitter 42 of FIG. 2. For instance, RF transceivers 54 may be configured to exchange RF signals with one or more components of system 2, such as controller 4B.

Enhanced driver modules 52, in some examples, may include a measurement module of measurement modules 47, which may be configured to perform operations similar to measurement module 46 of FIG. 2. For instance, measurement modules 47 may be configured to measure one or more operational values. As one example, measurement module 47A may be configured to measure one or more operational values of transistor 26A and/or load 10. As another example, measurement module 47B may be configured to measure one or more operational values of transistor 26B and/or load 10.

Enhanced driver modules 52, in some examples, may include a logic of logic 56 and a driver of drivers 36, which may be configured to perform operations similar to a logic of logic 34, logic 44, and a driver of drivers 36 of FIG. 2. For instance, logic 56A and driver 36A may be configured to generate signals to operate transistor 26A based on the control signals received from controller 4A, and to cause RF transceiver 54A to output RF signals representing at least one of the one or more operational values to one or more components of system 2B, such as controller 4B.

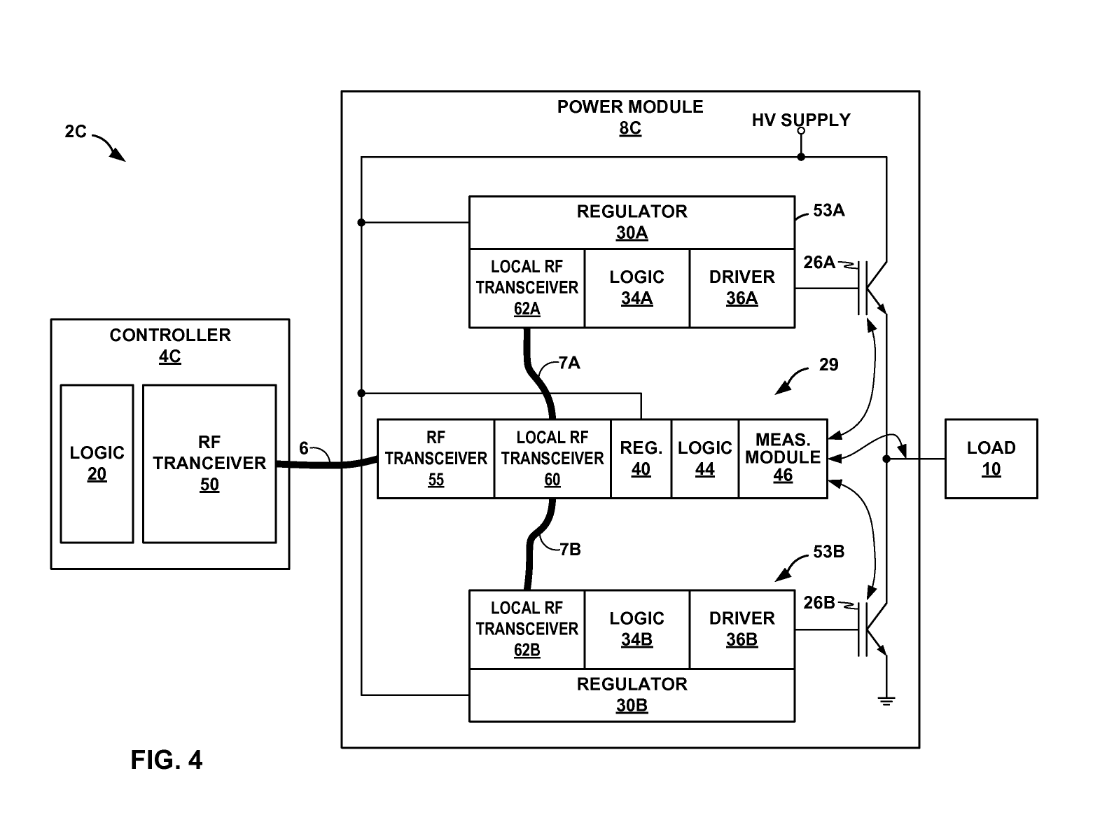

FIG. 4 is a conceptual diagram illustrating details of another example of system 2 of FIG. 1 that includes one or more waveguides configured to enable communication between galvanically isolated components, in accordance with one or more exemplary techniques of this disclosure. System 2C may be an example of system 2 of FIG. 1. As illustrated in FIG. 4, system 2C includes controller 4C, waveguide 6, power module 8C, and load 10. In some examples, system 2C may include one or more components not illustrated in FIG. 4, such as one or more sensors, which may be configured to perform operations similar to sensors 12 of FIG. 1.

In some examples, system 2C may be configured to perform operations similar to system 2 of FIG. 1, system 2A of FIG. 2, and system 2B or FIG. 3. However, as opposed to systems 2A and 2B which are illustrated as utilizing separate waveguides for each driver module, system 2C may utilize a single waveguide of waveguides 6 for all driver modules. In other words, FIG. 3 illustrates an example where controller 4B and power module 8B are connected by a single waveguide.

In some examples, system 2C may include controller 4C, which may be configured to perform operations similar to controller 4 of FIG. 1, controller 4A of FIG. 2, and controller 4B of FIG. 3. For instance, controller 4C may be configured to control operation of one or more other components of system 2C, such as load 10. As illustrated in FIG. 4, controller 4C may include RF transceiver 50, and logic 20. Similar to controller 4 of FIG. 1, controller 4C may be powered by a low voltage domain. For instance, the components of controller 4C (e.g., RF transceiver 50, and/or logic 20) may be powered by a power signal with a voltage of 3.3V, 5V, 12V, 24V, or another suitable voltage, which may be chosen or designed for a specific type of system.

In some examples, system 2C may include power module 8C, which may be configured to perform operations similar to power module 8 of FIG. 1, power module 8A of FIG. 2, and power module 8B of FIG. 3. For instance, power module 8C may be configured to may be configured to output a power signal to load 10 based on control signals received from controller 4C. As illustrated in FIG. 4, power module 8C may include local driver modules 53A and 53B (collectively, “local driver modules 53”), communication and feedback module 29 (C&F module 29), waveguides 7A and 7B (collectively, “waveguides 7”), and transistors 26. Similar to power module 8 of FIG. 1, power module 8C may receive power from a high voltage domain. For instance, one or more components of power module 8C (e.g., local driver modules 53, C&F module 29, and/or transistors 26) may be powered by a power signal with a voltage of 100V, 200V, 400V, 600V, or another suitable voltage.

Power module 8C, in some examples, may include waveguides 7, which may be configured to may be configured to guide RF signals. In some examples, waveguides 7 may be made from an insulating material, such as plastic. As such, even where a waveguide of waveguides 7 is connected to both C&F module 29 and a local driver module of local driver modules 53, C&F module 29 and the local driver module may remain galvanically isolated. In some examples, a length of a waveguide of waveguides 7 may be shorter than a length of a waveguide of waveguides 6. As such, in some examples, communication via a waveguide of waveguides 7 may be simplified, with respect to communication via a waveguide of waveguides 6, by reduction of the transmit power or reduction of the carrier frequency in accordance with an increase of the waveguide dimensions, or by protocol simplifications like an unidirectional PWM modulated OOK (on off keying).

Power module 8C, in some examples, may include local driver modules 53, which may be configured to perform operations similar to driver modules 24 of FIG. 2. For instance, each of local driver modules 53 may be configured to generate signals to operate transistors 26. However, as opposed to driver modules 24, which receive RF signals directly from controller 4A, local driver modules 53 may receive RF signals from C&F module 29. As illustrated in FIG. 4, local driver modules 53 may include a regulator of regulators 30, a local RF transceiver of local RF transceivers 62A and 62B (collectively, local RF transceivers 62″), a logic of logic 34, and a driver of drivers 36. For instance, local driver module 53A may include local RF transceiver 62A, logic 34A, and driver 36A; and local driver module 53B may include local RF transceiver 62B, logic 34B, and driver 36B.

Local driver modules 53, in some examples, may include a local RF transceiver of local RF transceivers 62, which may be configured to perform operations similar to an RF transceiver of RF transceivers 54 of FIG. 3. However, as opposed to directly exchanging RF signals with controller 4B, local RF transceivers 62 may be configured to exchange RF signals with one or more components of power module 8C, such as local RF transceiver 60 of C&F module 29.

In some examples, system 2C may include C&F module 29, which may be configured to perform operations similar to feedback module 28 and RF transceivers 54 of FIG. 2. For instance, C&F module 29 may be configured to provide feedback information to controller 4C, and to receive RF signals from controller 4C. As illustrated in FIG. 4, C&F module 29 may include RF transceiver 55, local RF transceiver 60, regulator 40, logic 44, and measurement module 46.

C&F module 29, in some examples, may include RF transceiver 55 and local RF transceiver 60. RF transceiver 55 may be configured to perform operations similar to RF transceivers 54 of FIG. 3. For instance, RF transceiver 55 may be configured to exchange RF signals with one or more components of system 2, such as controller 4B. However, as opposed to each power module communicating with controller 4C separately (i.e., via separate waveguides), RF transceiver 55 may enable multiple local power modules to communicate with controller 4C via a single waveguide.

C&F module 29, in some examples, may include regulator 40, which may be configured to perform operations similar to regulators 30. For instance, regulator 40 may be configured to supply components of C&F module 29 with one or more local, galvanically decoupled, low voltages generated from the high voltage supply. In some examples, as opposed to including regulator 40, C&F module 29 may receive power from one of regulators 30.

In operation, RF transceiver 50 may output RF signals to RF transceiver 55. For instance, RF transceiver 50 may output RF signals representing control signals for local power module 53A. RF transceiver 55 may demodulate the RF signals, and logic 44 may determine whether the signals are for local power module 53A or local power module 53B. As one example, logic 44 may determine that the signals are control signals for local power module 53A where the control signals are addressed to local power module 53A. As another example, logic 44 may determine that the control signals are for local power module 53A where the control signals are received in a particular pattern (i.e., alternating between control signals for local power module 53A and local power module 53B). In some examples, controller 4C may encode the control signals with a very high hamming distance, e.g., so as to reduce the likelihood of an inadvertent switching. In some examples, controller 4C may repeat the command for the actual state and acceptance rules for switching sequences can be monitored. In some examples, such as where transmission via waveguides 6 may reach 10 Gigabits per second data rates, controller 4C may use a 16 Bit code to specify the switching state (i.e., of transistors 26), the delay introduced by RF transmission may be approximately 2 nanoseconds.

Logic 44 may cause local RF transceiver 60 to output control signals to the determined local power module of local power modules 53. For instance, if the signal received by RF transceiver 55 is a command to cause transistor 26A to allow current to flow from the HV supply to load 10, logic 44 may output a PWM control signal, and cause local RF transceiver 60 to output RF signals representing the PWM control signal to local RF transceiver 62A. For instance, local RF transceiver 60 may modulate the PWM control signal with an RF carrier. Local RF transceiver 62A may demodulate the PWM control signal, and output the demodulated PWM control signal to logic 34A which, along with driver 36A, may cause transistor 26A to allow current to flow from the HV supply to load 10.

In some examples, such as the example FIG. 4, the RF signals exchanged by local RF transceivers 62 and local RF transceiver 60 may be guided by waveguides 7. For instance, the RF signals exchanged by local RF transceiver 62A and local RF transceiver 60 may be guided by waveguide 7A, and the RF signals exchanged by local RF transceiver 62B and local RF transceiver 60 may be guided by waveguide 7B. In some examples, waveguides 7 may be omitted such that local RF transceivers 62 and local RF transceiver 60 are wirelessly linked. In some examples, in order to decrease the isolation distance between respective antennas of local RF transceivers 62 and local RF transceiver 60, an isolator material may be placed in between both or both antennas may be molded into the same isolator. In either of these cases, system 2C may enable communication between controller 4C and power module 8C, while maintain galvanic isolation between controller 4C, local driver modules 53, and C&F module 29.

In some examples, the communication between RF transceiver 50 and RF transceiver 55 may be half duplex time-division multiple access (TDMA), full duplex frequency division multiple access (FDMA), code-division multiple access (CDMA), or any other suitable arrangement. Similarly, the communication between local RF transceiver 60 and local RF transceivers 62 may be half duplex TDMA, full duplex FDMA, or any other suitable arrangement.

In some examples, while illustrated in FIG. 4 as a separate component, C&F module 29 may be combined with a driver module, which may be referred to as a master driver module. In such examples, the power module may include the master driver module and one or more local driver modules. Similar to the example of FIG. 4, the master driver module may operate as a hub for communication with the controller.

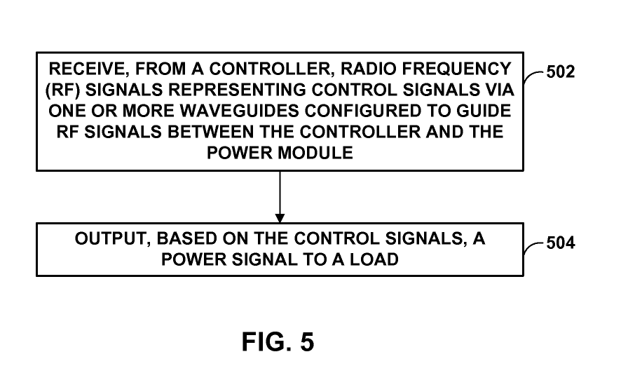

FIG. 5 is a flowchart illustrating exemplary operations of an example power module which communicates with a controller via one or more waveguides, in accordance with one or more techniques of this disclosure. For purposes of illustration only, the example operations are described below within the context of power module 8 as shown in FIG. 1 and power module 8A as shown in FIG. 2.

In accordance with one or more techniques of this disclosure, a receiver of power module 8 may receive, from a controller, radio frequency (RF) signals representing control signals via one or more waveguides configured to guide RF signals between the controller and the power module (502). For instance, RF receiver 32A of driver module 24A of power module 8A may receive, from RF transmitter 16A of controller 4A, RF signals representing control signals via waveguide 6A. As discussed above, power module 8 may be galvanically isolated from the controller.

Power module 8 may output, based on the control signals, a power signal to a load (504). For instance, driver 36A of driver module 24A may cause transistor 26A of power module 8A to output a power signal to load 10 based on the received control signals. In this way, power module 8 may receive control signals from a controller while remaining galvanically isolated from the controller.

As discussed above, in some examples, a measurement module of power module 8 may measure one or more operational values of power module 8. In such example, a transmitter of power module 8 may output RF signals representing the one or more operational values to the controller. In this way, power module 8 may bi-directionally communicate with the controller while remaining galvanically isolated from the controller.

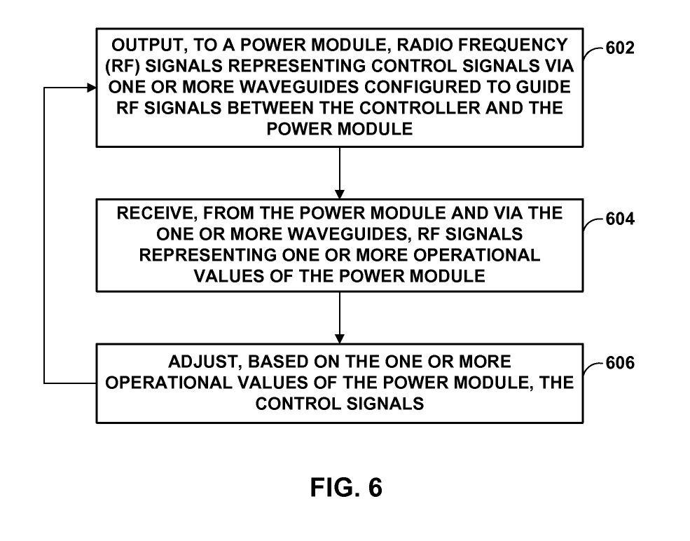

FIG. 6 is a flowchart illustrating exemplary operations of an example controller which communicates with a power module via one or more waveguides, in accordance with one or more techniques of this disclosure. For purposes of illustration only, the example operations are described below within the context of controller 4 as shown in FIG. 1 and controller 4A as shown in FIG. 2.

In accordance with one or more techniques of this disclosure, controller 4 may output, to a power module, radio frequency (RF) signals representing control signals via one or more waveguides configured to guide RF signals between controller 4 and the power module (602). For instance, logic 20 of controller 4A may generate a PWM control signal, RF transmitter 16A of controller 4A may modulate the PWM control signal with an RF carrier and output the modulated PWM control signal to the power module via waveguide 6A.

Controller 4 may receive, from the power module and via the one or more waveguides, RF signals representing one or more operational values of the power module (604). For instance, RF receiver 18 of controller 4A may receive, from power module 8A, RF signals representing a temperature of a transistor of power module 8A.

Controller 4 may adjust, based on the one or more operational values of the power module, the control signals (606). For instance, if the temperature of the transistor of power module 8A is above a threshold, logic 20 may adjust the control signals to reduce the temperature of the transistor. As one example, logic 20 may adjust the control signals to reduce a duty cycle of the transistor. Controller 4 may output the adjusted control signals to the power module (602). In this way, controller 4 may output control signals to a power module while remaining galvanically isolated from the power module.

The following examples may illustrate one or more aspects of the disclosure.

Example 1

A system comprising: one or more waveguides configured to guide radio frequency (RF) signals; a controller comprising a transmitter configured to output RF signals representing a control signal via the one or more waveguides; and a power module comprising: a receiver configured to receive the RF signals representing the control signal from the controller via the one or more waveguides; and a driver configured to output a power signal to a load based on the control signal.

### Example 2

The system of example 1, wherein a voltage level at which the controller is supplied is at least an order of magnitude greater than a voltage level at which the power module is supplied.

### Example 3

The system of any combination of examples 1-2, wherein the power module further comprises: a measurement module configured to measure one or more operational values of the power module; and a transmitter configured to output RF signals representing the one or more operational values to the controller via the one or more waveguides, wherein the controller further comprises a receiver configured to receive RF signals representing the one or more operational values from the power module via the one or more waveguides.

### Example 4

The system of any combination of examples 1-3, wherein the receiver of the power module is configured to receive the RF signals representing the control signal from the controller via a first waveguide of the one or more waveguides, wherein the transmitter of the power module is configured to output signals representing the one or more operational values to the controller via a second waveguide of the one or more waveguides.

### Example 5

The system of any combination of examples 1-4, wherein the receiver of the power module is configured to receive the RF signals representing the control signal from the controller via a particular waveguide of the one or more waveguides, wherein the transmitter of the power module is configured to output signals representing the one or more operational values to the controller via the particular waveguide.

### Example 6

The system of any combination of examples 1-5, wherein the transmitter of the power module and the receiver of the power module are configured to communicate with other components of the power module via a local RF link.

### Example 7

The system of any combination of examples 1-6, wherein the particular waveguide is a first waveguide of the one or more waveguides, and wherein signals of the local RF link are guided by a second waveguide of the one or more waveguides.

### Example 8

The system of any combination of examples 1-7, wherein signals of the local RF link are not guided by the one or more waveguides.

### Example 9

The system of any combination of examples 1-8, wherein the driver comprises a first driver configured to output a first power signal to the load, the power module further comprising a second driver configured to output a second power signal to the load.

### Example 10

The system of any combination of examples 1-9, wherein the receiver of the power module comprises a first receiver configured to receive, from the controller and via a first waveguide of the one or more waveguides, RF signals representing a control signal for the first driver, the power module further comprising: a second receiver configured receive, from the controller and via a second waveguide of the one or more waveguides, RF signals representing a control signal for the second driver.

### Example 11

The system of any combination of examples 1-10, wherein the measurement module comprises a first measurement module configured to measure one or more operational values of the first driver, the transmitter of the power module is a first transmitter of the power module configured to output RF signals representing the one or more operational values of the first driver to the controller via the first waveguide, the power module further comprising: a second measurement module configured to measure one or more operational values of the second driver; and a second transmitter configured to output RF signals representing the one or more operational values of the second driver to the controller via the second waveguide.

### Example 12

The system of any combination of examples 1-11, wherein the transmitter of the power module is configured to output the RF signals representing the one or more operational values to the controller via a third waveguide.

### Example 13

The system of any combination of examples 1-12, further comprising one or more sensors configured to measure one or more operational values of the load, wherein the one or more sensors are galvanically coupled to the controller.

### Example 14

The system of any combination of examples 1-13, wherein the one or more waveguides comprise one or more plastic waveguides.

### Example 15

A method comprising: receiving, by a receiver of power module and from a controller, radio frequency (RF) signals representing control signals via one or more waveguides configured to guide RF signals between the controller and the power module, wherein the power module is galvanically isolated from the controller; and outputting, by a driver of the power module and based on the control signals, a power signal to a load.

### Example 16

The method of example 15, wherein the waveguide is a first waveguide of the one or more waveguides, the method further comprising: measuring, by a measurement module, one or more operational values of the power module; transmitting, by a transmitter of the power module, RF signals representing the one or more operational values of the power module via a second waveguide of the one or more waveguides.

### Example 17

The method of any combination of examples 15-16, further comprising: measuring, by a measurement module, one or more operational values of the power module; transmitting, by a transmitter of the power module, RF signals representing the one or more operational values of the power module via the waveguide.

### Example 18

The method of any combination of examples 15-17, further comprising: communicating, by the transmitter of the power module and the receiver of the power module, via a local RF link such that the transmitter of the power module is galvanically isolated from the receiver of the power module.

### Example 19

A power module comprising: a receiver configured to receive, from a controller, radio frequency (RF) signals representing control signals via one or more waveguides configured to guide RF signals between the controller to the power module such that of the power module is galvanically isolated from the controller; and a driver configured to output a power signal to a load based on the control signals.

### Example 20

A power module comprising: means for receiving, from a controller, radio frequency (RF) signals representing control signals via a waveguide configured to guide RF signals between the controller to the power module such that of the power module is galvanically isolated from the controller; and means for outputting a power signal to a load based on the control signals.

### Example 21

The power module of example 20, further comprising means for performing the method of any combination of examples 15-18.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects have been described in this disclosure. These and other aspects are within the scope of the following claims.

1. A system comprising:
one or more waveguides configured to guide radio frequency (RF) signals;
a controller comprising a transmitter configured to output RF signals representing a control signal via the one or more waveguides; and
a power module comprising:
a receiver configured to receive the RF signals representing the control signal from the controller via the one or more waveguides; and
a driver configured to output a power signal to a load based on the control signal.

2. The system of claim 1, wherein a voltage level at which the controller is supplied is at least an order of magnitude greater than a voltage level at which the power module is supplied.

3. The system of claim 1,
wherein the power module further comprises:
a measurement module configured to measure one or more operational values of the power module; and
a transmitter configured to output RF signals representing the one or more operational values to the controller via the one or more waveguides,
wherein the controller further comprises a receiver configured to receive RF signals representing the one or more operational values from the power module via the one or more waveguides.

4. The system of claim 3, wherein the receiver of the power module is configured to receive the RF signals representing the control signal from the controller via a first waveguide of the one or more waveguides, wherein the transmitter of the power module is configured to output signals representing the one or more operational values to the controller via a second waveguide of the one or more waveguides.

5. The system of claim 3, wherein the receiver of the power module is configured to receive the RF signals representing the control signal from the controller via a particular waveguide of the one or more waveguides, wherein the transmitter of the power module is configured to output signals representing the one or more operational values to the controller via the particular waveguide.

6. The system of claim 5, wherein the transmitter of the power module and the receiver of the power module are configured to communicate with other components of the power module via a local RF link.

7. The system of claim 6, wherein the particular waveguide is a first waveguide of the one or more waveguides, and wherein signals of the local RF link are guided by a second waveguide of the one or more waveguides.

8. The system of claim 6, wherein signals of the local RF link are not guided by the one or more waveguides.

9. The system of claim 3, wherein the driver comprises a first driver configured to output a first power signal to the load, the power module further comprising a second driver configured to output a second power signal to the load.

10. The system of claim 9, wherein the receiver of the power module comprises a first receiver configured to receive, from the controller and via a first waveguide of the one or more waveguides, RF signals representing a control signal for the first driver, the power module further comprising:
a second receiver configured receive, from the controller and via a second waveguide of the one or more waveguides, RF signals representing a control signal for the second driver.

11. The system of claim 10, wherein the measurement module comprises a first measurement module configured to measure one or more operational values of the first driver, the transmitter of the power module is a first transmitter of the power module configured to output RF signals representing the one or more operational values of the first driver to the controller via the first waveguide, the power module further comprising:
a second measurement module configured to measure one or more operational values of the second driver; and
a second transmitter configured to output RF signals representing the one or more operational values of the second driver to the controller via the second waveguide.

12. The system of claim 10, wherein the transmitter of the power module is configured to output the RF signals representing the one or more operational values to the controller via a third waveguide.

13. The system of claim 3, further comprising one or more sensors configured to measure one or more operational values of the load, wherein the one or more sensors are galvanically coupled to the controller.

14. The system of claim 1, wherein the one or more waveguides comprise one or more plastic waveguides.

15. A method comprising:
receiving, by a receiver of power module and from a controller, radio frequency (RF) signals representing control signals via one or more waveguides configured to guide RF signals between the controller and the power module, wherein the power module is galvanically isolated from the controller; and
outputting, by a driver of the power module and based on the control signals, a power signal to a load.

16. The method of claim 15, wherein the waveguide is a first waveguide of the one or more waveguides, the method further comprising:
measuring, by a measurement module, one or more operational values of the power module;
transmitting, by a transmitter of the power module, RF signals representing the one or more operational values of the power module via a second waveguide of the one or more waveguides.

17. The method of claim 15, further comprising:
measuring, by a measurement module, one or more operational values of the power module;
transmitting, by a transmitter of the power module, RF signals representing the one or more operational values of the power module via the waveguide.

18. The method of claim 17, further comprising:
communicating, by the transmitter of the power module and the receiver of the power module, via a local RF link such that the transmitter of the power module is galvanically isolated from the receiver of the power module.

19. A power module comprising:
a receiver configured to receive, from a controller, radio frequency (RF) signals representing control signals via one or more waveguides configured to guide RF signals between the controller to the power module such that of the power module is galvanically isolated from the controller; and
a driver configured to output a power signal to a load based on the control signals.

20. A power module comprising:
means for receiving, from a controller, radio frequency (RF) signals representing control signals via a waveguide configured to guide RF signals between the controller to the power module such that of the power module is galvanically isolated from the controller; and
means for outputting a power signal to a load based on the control signals.
